(19) United States
(12) Patent Application Publication
(10) Pub. No.: US 2009/0125562 A1
(43) Pub. Date: May 14, 2009

(54) METHODS AND SYSTEMS INVOLVING CHECKING MEMORY INTEGRITY

(75) Inventors: Yasunao Katayama, Tokyo (JP); Atsuya Okazaki, Kanagawa (JP)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/937,243

(22) Filed: Nov. 8, 2007

(51) Int. Cl. G06F 12/00

(52) U.S. Cl. 707/200; 711/E12.001

(57) ABSTRACT

A method for monitoring memory integrity comprising, receiving a data read access request, updating a data read history register responsive to receiving a data read access request, the update comprising storing a first register value, wherein the first register value is defined by a previous register value and a first symmetric key encryption function, updating a data write history register in further response to receiving the data read access request, the update comprising storing a second register value, wherein the second register value is defined by a previous register value and a second symmetric key encryption function, receiving a data write access request, updating the data read history register responsive to receiving a data write access request, the update comprising storing the first register value, and updating the data write history register in further response to receiving the data write access request, the update comprising storing the second register value.

### BACKGROUND OF THE INVENTION

1. Field of the Invention

This invention relates generally to computer storage media and, more specifically, to a method and system for checking the integrity of computer memory.

2. Description of Background

In existing methods, such as those described in U.S. Patent Application Number 20060161773, a processor updates a read/write history register (R/W) is after each read and write memory access (Eqs. 1, 2, and 3). When the processor updates the write history register (Eq. 2), a counter value storing the number of writes to a memory is encrypted and used as a new counter value (Eq. 3) in order to make a future counter value unpredictable for attackers.

Rₜ:=Rₜ₋₁⊕Eₖ(d, cᵣ, a), (1)

Wₜ:=Wₜ₋₁⊕Eₖ(d, c_{w}, a), (2)

where c_{w}=cᵣ+E_{c}(cᵣ). (3)

Wherein Rₜ and Wₜ are stored values in the R/W register for a transaction t, Eₖ is an encryption function using an encryption key k, d is data, c is a counter value, a is a data address, and E_{c} is an encryption function using c as an encryption key.

The method requires an encryption circuit for encrypting the counter value and a large adder that handles multiple bits. Furthermore, the encryption processing occupies about half the latency of the entire integrity check.

### SUMMARY OF THE INVENTION

The shortcomings of the prior art are overcome and additional advantages are achieved through an exemplary method for monitoring memory integrity, the method comprising, receiving a data read access request, updating a data read history register responsive to receiving a data read access request, the update comprising storing a first register value, wherein the first register value is defined by a previous register value and a first function Rₜ:=Rₜ₋₁⊕Eₖ(d, r, a), wherein t is a transaction number, d represents stored data, r is a random number, a is an address of the data, Eₖ is a symmetric key encryption function, and k is a key of the symmetric key encryption function, updating a data write history register in further response to receiving the data read access request, the update comprising storing a second register value, wherein the second register value is defined by a previous register value and a second function Wₜ:=Wₜ₋₁⊕Eₖ(d, r, a), receiving a data write access request, updating the data read history register responsive to receiving a data write access request, the update comprising storing the first register value, and updating the data write history register in further response to receiving the data write access request, the update comprising storing the second register value.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a block diagram of an example of a prior art memory controller.

FIG. 2 illustrates a block diagram of an exemplary embodiment of a memory controller.

FIG. 3 illustrates a flow chart of an exemplary method involving checking memory integrity.

The detailed description explains the preferred embodiments of the invention, together with advantages and features, by way of example with reference to the drawings.

### DETAILED DESCRIPTION OF THE INVENTION

Systems and methods involving checking memory integrity are provided. Several exemplary embodiments are described.

Memory integrity ensures that a set of read data is the last data written by a memory controller such as, for example, a processor. To ensure memory integrity, previous methods generate read access and write access in pairs and verify the transactions. For example, when a cache memory controller issues a read access request, an external memory controller makes a write access after the read access. When a write access request is issued, the external memory controller makes the write access after a read access. This may be expressed in the equation below, transactions t, that is, read data and write data d, their addresses a and the order c of the transactions on the reading channel are the same as those on the write channel.

Σₐt_{w}{dₐ, a, c}=Σₐtᵣ{dₐ, a, c}

To achieve this, read/write history registers are provided on the write and read channels to store the history of transactions. Each of the registers is updated after each memory access. The update is made by using exclusive OR. However, the same history can be held for different transaction sequences if calculated as:

R=⊕ₐt{dₐ, a, c}, W=⊕ₐt{dₐ, a, c}

Therefore, transactions are scrambled using a hash function H before storing.

R=⊕ₐH(t{dₐ, a, c}), W=⊕ₐH(t{dₐ, a, c})

If only the simple hash function is used, malicious attackers can generate collisions. Therefore, a symmetric key cryptography function Eₖ is used. The key k is hidden within the processor and therefore is not observable by an attacker.

R=⊕ₐEₖ(t{dₐ, a, c}), W=⊕ₐEₖ(t{dₐ, a, c})

However, the encryption cannot prevent an attack that forces the processor to read even numbers of the same transaction, because of the property of exclusive OR. For example:

Eₖ(t₀)⊕Eₖ(t₁)=Eₖ(t₀)⊕Eₖ(t₁)⊕Eₖ(t₂)⊕Eₖ(t₂)

Therefore, a global counter register g is provided that counts a number of memory accesses within the processor. A number of write accesses to each memory address is compared with the total count of the counter c (g=Σc). Thus, such attack can be detected.

An attack that replaces transactions themselves cannot be prevented also because of the property of exclusive OR. For example

Eₖ(t₀)⊕Eₖ(t₁)=Eₖ(t₁)⊕Eₖ(t₀)
that is,

Eₖ(t₀{d₀, a₀, c₀})⊕Eₖ(t₁{d₁, a₁, c₁})=Eₖ(t₁{d₁, a₁, c₁})⊕Eₖ(t₀{d₀, a₀, c₀})

The replacement attack is still possible because a future counter value can be predicted if the order (counter) c of transactions t{dₐ, a, c} is incremented after every memory access. In order to prevent a future counter value from being predicted, a new counter c_{w} is generated by encrypting a read transaction tᵣ and a read counter cᵣ. The global counter is also updated accordingly.

c_{w}=cᵣ+E_{c}(cᵣ)

g+=E_{c}(cᵣ)

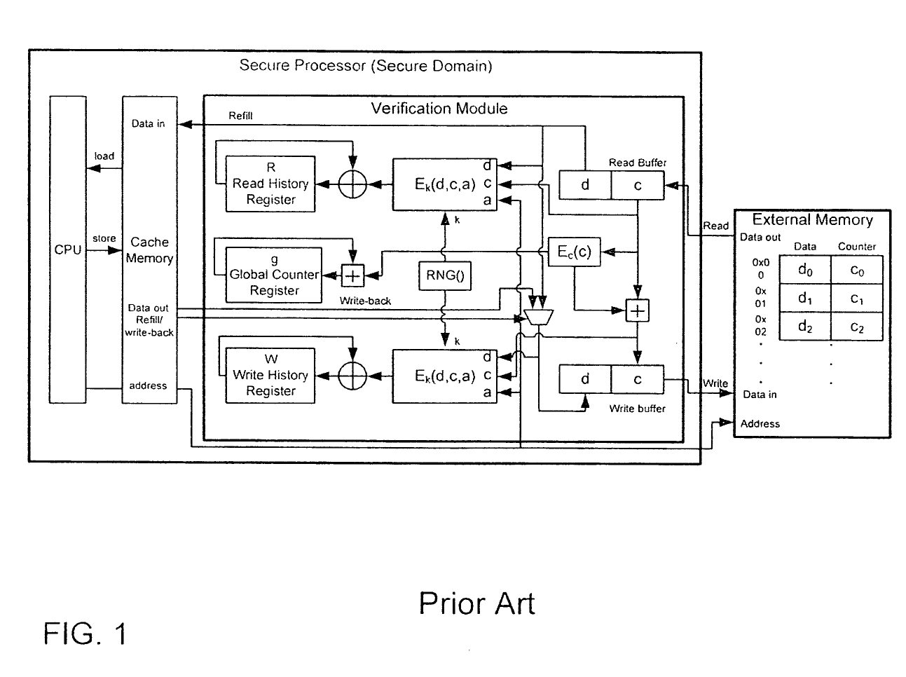

Updating the counter in this way makes it difficult to predict future counter values and therefore can prevent the replacement attack. A block diagram of an example of a memory controller using the above-described previous method is illustrated in FIG. 1.

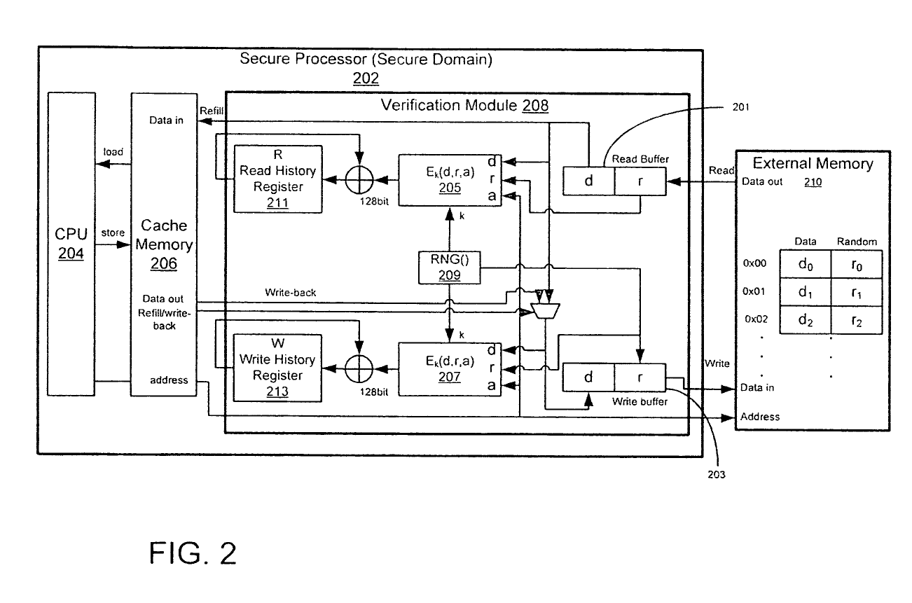

FIG. 2 illustrates a block diagram of an exemplary embodiment of a memory controller. The illustrated exemplary embodiment includes a secure processor 202 that includes a central processing unit (CPU) 204 communicatively linked to a cache memory 206. A verification module 208 is communicatively linked to the cache memory 206 and an external memory 210. The verification module 208 may be, for example, a processor that includes a read buffer 201, a write buffer 203, a first function box 205, a second function box 207, a random number generator (RNG) 209, a read history register 211, and a write history register 213.

In operation, the exemplary embodiment of the verification module 208 ensures memory integrity by ensuring that the read data is the last data written by the cache memory 206. The verification module 208 generates read access and write access always in pairs, and verifies the transactions t that is, read data and write data d, their addresses a and the unpredictable random number r of the transactions on the reading channel are the same as those on the write channel.

Σₐt_{w}{d, r, a}=Σₐtᵣ{d, r, a}

The verification module 208 includes the read/write history registers 211 and 213 that are provided on write and read channels to store the history of the transactions. Each of the registers 211 and 213 is updated after each memory access. The update is made by using exclusive OR. However, the same history can be held for different transaction sequences (R=W) if calculated as:

R=⊕ₐt{d, r, a}, W=⊕ₐt{d, r, a}

Therefore, transactions are scrambled using a hash function H before storing.

R=⊕ₐH(t{d, r, a}), W=⊕ₐH(t{d, r, a})

If only the simple hash function is used, malicious attackers can generate collisions. Therefore, a symmetric key cryptography function Eₖ is used. The key k is hidden within the processor and therefore is not observable by an attacker.

R=⊕ₐEₖ(t{d, r, a}), W=⊕ₐEₖ(t{d, r, a})

However, the encryption cannot prevent an attack that forces the processor to read even numbers of the same transaction, because of the property of exclusive OR. For example:

Eₖ(t₀)⊕Eₖ(t₁)=Eₖ(t₀)⊕Eₖ(t₁)⊕Eₖ(t₂)⊕Eₖ(t₂)

Using the random number enables the verification module 208 to verify the integrity of the data without using a global counter register update that uses encryption for integrity or multiple multi-bit adder circuits. This is illustrated by the equations:

Rₜ:=Rₜ₋₁⊕Eₖ(d, r, a),

Wₜ:=Wₜ₋₁⊕Eₖ(d, r, a)

where the RNG 209 generates r, and r is an unpredictable random number that varies at each memory access. The use of r allows the verification module 208 to not encrypt a counter and maintain memory integrity.

As discussed above regarding the previous method, an attacker may attempt to perform a replacement attack when the attack repeats the same transaction an even number of times because of the property of exclusive OR. To perform a replacement attack, pairs (t₁, r₁) and (t₂, r₂) must be replaced as follows. A transaction in the following description represents data and its address (t:={dₐ, a}).

W=Eₖ(t₀, r₀)⊕Eₖ(t₁, r₁)⊕Eₖ(t₂, r₂)⊕Eₖ(t₃, r₃)

R=Eₖ(t₀, r₀)⊕Eₖ(t₂, r₂)⊕Eₖ(t₁, r₁)⊕Eₖ(t₃, r₃)

When write access to t₁ is made, t₂ and r₂ must be read. However, even if t₂ is known, r₂ is an unpredictable random number that will be generated in the future and therefore cannot be replaced. Thus, the replacement attack fails.

Using another method of attack, an attacker may attempt to force the processor to read even numbers of the same transaction

W=Eₖ(t₀, r₀)⊕Eₖ(t₁, r₁)⊕Eₖ(t₁, r₁)⊕Eₖ(t₃, r₃)=Eₖ(t₀, r₀)⊕Eₖ(t₃, r₃)

W=Eₖ(t₀, r₀)⊕Eₖ(tₘ, rₘ)⊕Eₖ(tₘ, rₘ)⊕Eₖ(t₃, r₃)=Eₖ(t₀, r₀)⊕i Eₖ(t₃, r₃)

W═R

However, since the random number r is changed at every memory access, r₁ cannot be written twice. Therefore

W=Eₖ(t₀, r₀)⊕Eₖ(t₁, r₁)⊕Eₖ(t₁, r₂)⊕Eₖ(t₃, r₃)=Eₖ(t₀, r₀)⊕Eₖ(t₃, r₃)

showing that

W≠R

Therefore, the attack can be also detected.

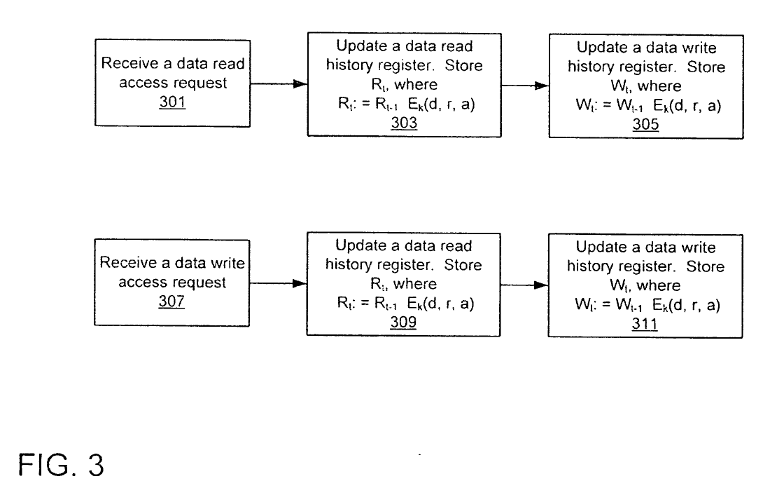

FIG. 3 illustrates a flow diagram of an exemplary method of checking memory integrity. In this regard, referring to block 301 if a data read access request, the data read history register is updated in block 303 by storing Rₜ where Rₜ:=Rₜ₋₁⊕Eₖ(d, r, a). In block 305 the data write history register is updated by storing Wₜ where Wₜ:=Wₜ₋₁⊕Eₖ(d, r, a). If a data write access request is received in block 307 the data read history register is updated in block 309 by storing Rₜ where Rₜ:=Rₜ₋₁⊕Eₖ(d, r, a), and the data write history register is updated by storing Wₜ where Wₜ:=Wₜ₋₁⊕Eₖ(d, r, a) in block 311.

The above-described embodiment reduces the circuit size and latency. The latency required for integrity check at every memory access can be reduced by about half because the processor does not encrypt the counter and encryption of only the read/write history registers is performed.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method for monitoring memory integrity, the method comprising:
receiving a data read access request;
receiving an unpredictable random number r, wherein the random number r is generated by a random number generator;
updating a data read history register responsive to receiving a data read access request, the update comprising storing a first register value, wherein the first register value is defined by a previous register value and a first function Rₜ:=Rₜ₋₁/Eₖ(d, r, a), wherein t is a transaction number, d represents stored data, a is an address of the data, Eₖ is a symmetric key encryption function, and k is a key of the symmetric key encryption function;
updating a data write history register in further response to receiving the data read access request, the update comprising storing a second register value, wherein the second register value is defined by a previous register value and a second function Wₜ:=Wₜ₋₁/Eₖ(d, r, a);
receiving a data write access request;
updating the data read history register responsive to receiving a data write access request, the update comprising storing the first register value; and
updating the data write history register in further response to receiving the data write access request, the update comprising storing the second register value.
